(19) United States
(12) Patent Application Publication
(10) Pub. No.: US 2004/0140666 A1
(43) Pub. Date: Jul. 22, 2004

(54) Hose coupler having detecting device

(76) Inventor: Yen Tang Lin, Taichung (TW)

Correspondence Address: Yen Tang LIN, P.O. Box 63-99, Taichung, 406, TW

(21) Appl. No.: 10/651,145

(22) Filed: Aug. 26, 2003

(30) Foreign Application Priority Data
Jan. 17, 2003 (TW) 092201040

(51) Int. Cl. F16L 35/00

(52) U.S. Cl. 285/93

(57) ABSTRACT

A hose coupler includes a tube having an inlet port to receive water and an outlet port for outward flowing of the water. A water temperature detecting device is engaged into the tube to detect water temperature of the water flowing through the tube, and a warning signal generating device is used to generate a warning signal when the water temperature reaches a predetermined temperature. The warning signal generating device includes one or more light devices or sound generating device to generate warning lights or sounds, and a switch device having two terminals engaged into the tube, and to be electrically coupled together with the water flowing through the tube.

### BACKGROUND OF THE INVENTION

1. Field of the Invention

The present invention relates to a hose coupler, and more particularly to a hose coupler having a detecting device to detect the water temperature flowing through the hose coupler and the hoses coupled to the hose coupler.

2. Description of the Prior Art

Typically, shower heads or other water spraying devices for bathing purposes are directly coupled to the hot water suppliers or to the hot water reservoir which may supply the hot water to the users.

However, the typical shower heads or other water spraying devices have no temperature sensing and/or indicating device to detect and show the water temperature for the users, such that many users, particularly the children or the elders are hurt by the hot water inadvertently.

The present invention has arisen to mitigate and/or obviate the afore-described disadvantages of the conventional shower heads or other water spraying devices.

### SUMMARY OF THE INVENTION

The primary objective of the present invention is to provide a hose coupler including a detecting device to detect the water temperature flowing through the hose coupler and the hoses coupled to the hose coupler, and to warn people when the water temperature is greater than the endurable temperature.

In accordance with one aspect of the invention, there is provided a hose coupler comprising a tube including an inlet port to receive water, and an outlet port for outward flowing of the water, a water temperature detecting device engaged into the tube to detect water temperature of the water flowing through the tube, and warning signal generating device for generating warning signal when the water temperature reaches a predetermined temperature.

The warning signal generating device includes at least one light device to generate warning lights. The warning signal generating device includes a circuit board, a CPU attached to the circuit board and coupled to the light device to control the light device to generate the warning lights. The warning signal generating device includes at least one battery coupled to the circuit board to energize the CPU and the light device.

The circuit board includes a switch device coupled thereto to control the circuit board. The switch device of the circuit board includes two terminals engaged into the tube, and to be electrically coupled together with the water flowing through the tube. A housing may further be provided and attached onto the tube, to receive the light device and the other elements in the housing. The warning signal generating device may also include a sound generating device for generating warning sounds.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial cross sectional view of a hose coupler in accordance with the present invention, taken along lines 1-1 of FIG. 2;

FIG. 2 is a plan schematic view of the hose coupler; and

FIGS. 3, 4 are enlarged partial cross sectional views taken along lines 3-3 and 4-4 of FIG. 1 respectively.

### DETAILED DESCRIPTION OF THE PREFERRED EMBODIMENT

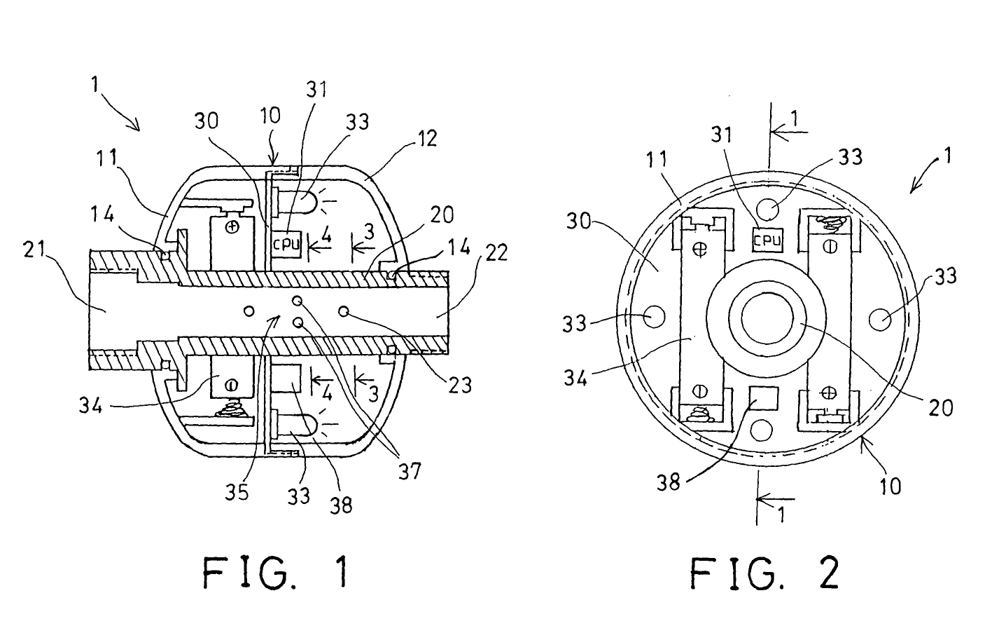

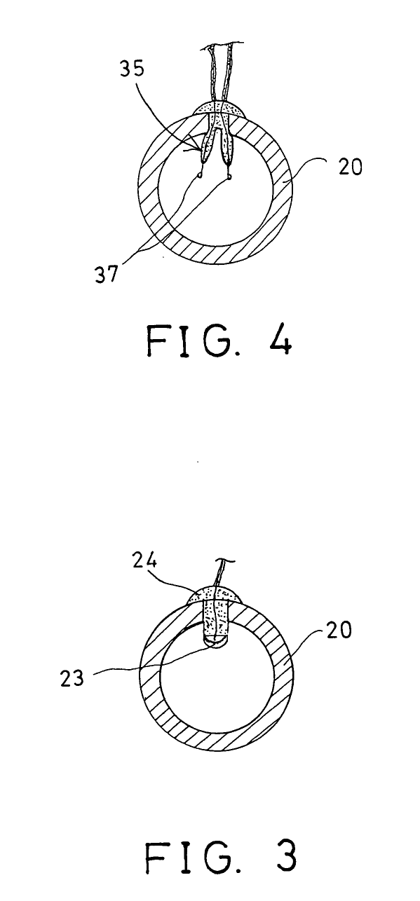

Referring to the drawings, and initially to FIGS. 1 and 2, a hose coupler 1 in accordance with the present invention comprises a housing 10 and a tube 20 engaged through and secured in the housing 10. The housing 10 may include two housing members 11, 12 secured together by fasteners (not shown), adhesive materials, or by welding processes, and may be secured onto the tube 20 with fasteners (not shown), or clamping rings 14 or the like.

The tube 20 includes an inlet port 21 for coupling, with hoses, to a water supplier or a water reservoir which may supply the water, such as the hot water to the tube 20. The tube 20 further includes an outlet port 22 for coupling to shower heads or other water spraying devices (not shown), directly or indirectly via hoses, for such as bathing purposes.

The tube 20 further includes a water temperature detecting device 23, such as a thermometer 23, engaged therein, in order to detect the water temperature flowing through the hose coupler 1 and/or the hoses coupled to the hose coupler 1. It is preferable that a sealing member 24 is engaged and sealed between the tube 20 and the water temperature detecting device 23, in order to make a water-tight seal between the tube 20 and the water temperature detecting device 23, and to prevent the water from flowing out of the tube 20 via the gap or the slit between the tube 20 and the water temperature detecting device 23.

A circuit board 30 is received and/or secured in the housing 10, and/or engaged or secured onto the tube 20, and includes a processor device 31, such as a central processing unit (CPU) 31 attached or secured thereon. One or more light bulbs or lamps or other light members 33 are attached or secured onto the circuit board 30, and electrically coupled to the CPU 31, for example. One or more batteries 34 may be secured in the housing 10 or secured onto the tube 20 or secured onto the circuit board 30, and electrically coupled to the CPU 31 and/or the light members 33, for energizing the CPU 31 and/or the light members 33, and/or the other electrical elements (not shown).

A switch device 35 is further provided and coupled to the circuit board 30 and/or to the CPU 31 and/or to the light members 33, for actuating the CPU 31 and/or to the light members 33, or for closing the electric circuit of the circuit board 30. For example, the switch device 35 may include two probes or terminals 37 extended into the tube 20, and to be electrically coupled together when the water flows through the tube 20.

Another warning member 38, such as a buzzer 38 or other sound generating devices may further be provided and coupled to the circuit board 30 and/or to the CPU 31, for being actuated by the CPU 31, and for generating warning sounds or for telling the water temperature of the water flowing through the tube 20, or the like.

In operation, when the water, particularly the hot water flows through the tube 20, the water flowing through the tube 20 may electrically couple the two probes or terminals 37 of the switch device 35 together, in order to enclose the electric circuit between the CPU 31 and/or to the light members 33 and/or the warning member 38 and the batteries 34, and for allowing the CPU 31 and/or to the light members 33 and/or the warning member 38 to be energized or actuated.

The CPU 31 may actuate the light members 33 to generate green light when the water temperature ranges from 36° C. to 40° C., for example. In addition, when the water temperature is 36° C., the light members 33 may flash slower similar to walking pace; and may flash quicker similar to jogging when the water temperature is around 37-39° C. The light members 33 may flash further quicker similar to racing when the water temperature is close to or equal to 40° C.

Similarly, the CPU 31 may actuate the light members 33 to generate yellow light when the water temperature ranges from 40° C. to 44° C., for example. In addition, when the water temperature is no greater than 41° C., the light members 33 may flash slower similar to walking pace; and may flash quicker similar to jogging when the water temperature is around 41-43° C. The light members 33 may flash further quicker similar to racing when the water temperature is close to or equal to 44° C.

Similarly, the CPU 31 may actuate the light members 33 to generate red light when the water temperature ranges from 44° C. to 48° C., for example. In addition, when the water temperature is no greater than 45° C., the light members 33 may flash slower similar to walking pace; and may flash quicker similar to jogging when the water temperature is around 45-47° C. The light members 33 may flash further quicker similar to racing when the water temperature is close to or even greater than 47° C.

It is to be noted that the light members 33 may also be controlled to generate either the yellow or the red light when the water temperature is more than 40° C. which may be predetermined and entered into the CPU 31, and which may be too hot for some of the users and which may hurt the other users.

Accordingly, the hose coupler in accordance with the present invention includes a detecting device to detect the water temperature flowing through the hose coupler and the hoses coupled to the hose coupler, and to warn people when the water temperature is greater than the endurable temperature.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A hose coupler comprising:
a tube including an inlet port to receive water, and an outlet port for outward flowing of the water,
a water temperature detecting device engaged into said tube to detect water temperature of the water flowing through said tube, and warning signal generating means for generating warning signal when the water temperature reaches a predetermined temperature.

2. The hose coupler as claimed in claim 1, wherein said warning signal generating means includes at least one light device to generate warning lights.

3. The hose coupler as claimed in claim 2, wherein said warning signal generating means includes a circuit board, a CPU attached to said circuit board and coupled to said at least one light device to control said at least one light device to generate the warning lights.

4. The hose coupler as claimed in claim 3, wherein said warning signal generating means includes at least one battery coupled to said circuit board to energize said CPU and said at least one light device.

5. The hose coupler as claimed in claim 3, wherein said circuit board includes a switch device coupled thereto to control said circuit board.

6. The hose coupler as claimed in claim 5, wherein said switch device of said circuit board includes two terminals engaged into said tube, and to be electrically coupled together with the water flowing through said tube.

7. The hose coupler as claimed in claim 2 further comprising a housing attached onto said tube, to receive said at least one light device in said housing.

8. The hose coupler as claimed in claim 1, wherein said warning signal generating means includes a sound generating device for generating warning sounds.
